(19) United States
(12) Patent Application Publication
(10) Pub. No.: US 2007/0241099 A1
(43) Pub. Date: Oct. 18, 2007

(54) Domestic Oven and Cooking Process that Uses the Same

(76) Inventors: Salvatore Sanna, Biandronno (IT); Paolo Crosta, Gavirate (IT); Gianpiero Santacatterina, Sangiano (IT); Nicola Bedetti, Como (IT)

Correspondence Address: MCGARRY BAIR PC, 32 Market Ave. SW, SUITE 500, GRAND RAPIDS, MI, 49503, US

(21) Appl. No.: 10/596,196

(22) PCT Filed: Dec. 3, 2004
(86) PCT No.: PCT/EP04/53267

§ 371 Date: Mar. 7, 2007

(30) Foreign Application Priority Data
Dec. 4, 2003 (IT) VA2003A000046

(51) Int. Cl. H05B 1/02

(52) U.S. Cl. 219/506

(57) ABSTRACT

A domestic oven comprises heating means, a gas sensor connected to a central processing and control unit and a user interface connected to the central processing unit by means of which the user can set the type of food placed in the oven compartment The user interface comprises means for setting the desired degree of cooking of the food and is capable of processing the signal of the gas sensor in such a way as to determine the optimal cooking end time of the food. The central processing unit interupts the electrical supply to the heating means on the basis either of said cooking end time, modified if necessary on the basis of degree of cooking set by the user, or of the food type set by the user.

The present invention concerns a domestic oven of the type comprising heating means, a gas sensor connected to a central processing and control unit and a user interface connected to said central processing unit by means of which the user can set the type of food placed in the oven compartment. The present invention also concerns a cooking process that uses the aforesaid oven.

Such a type of known oven is described for example in patents U.S. Pat. No. 4,331,855 and U.S. Pat. No. 4,463,238. Said ovens with one or more gas sensors have been designed in order to make it simpler to use domestic ovens in which, traditionally, methods for setting the cooking time are based mainly on recipes and not on the actual process for cooking the food.

The aim of the present invention is, by monitoring the gases emitted by the food during cooking, to provide an oven that makes it possible to understand and therefore to communicate to the user the actual degree of cooking of the food (well cooked, lightly cooked, over-cooked, becoming burnt) and, if necessary, to interact with the control of said oven with the aim of automatically achieving a desired cooking level, at the same time preventing the food from burning.

This aim is achieved by means of an oven having the characteristics specified in the attached main claim.

According to another characteristic of the present invention, the gas sensor is positioned in an optimal configuration, i.e. placed in the intake duct of the oven. Positioning the sensor correctly is not in fact easy, since it is exposed to dirt from the oven and to the high cooking temperatures of foods. The position of the sensor also significantly influences the type of signal supplied by said sensor. The above-mentioned position has been found to be optimal. The invention involves the use of a gas sensor of MOS type (Metal Oxide Semiconductor), already used for automatic cooking in some microwave ovens. It should be understood that other types of sensors, for example MOSFET (Metal Oxide Semiconductor Field-Effect) could be used.

The signal from the gas sensor is subject to pre-filtering through a filter with characteristics (bandwidth, attenuation, phase, etc.) depending on the food type. As a consequence of this operation, the signal is analysed with the aim of demonstrating some characteristics that can be correlated with the cooking of the food.

Further advantages and characteristics of an oven according to the present invention will be obvious from the following detailed description, supplied purely as a non-limitative example, with reference to the attached drawings in which:

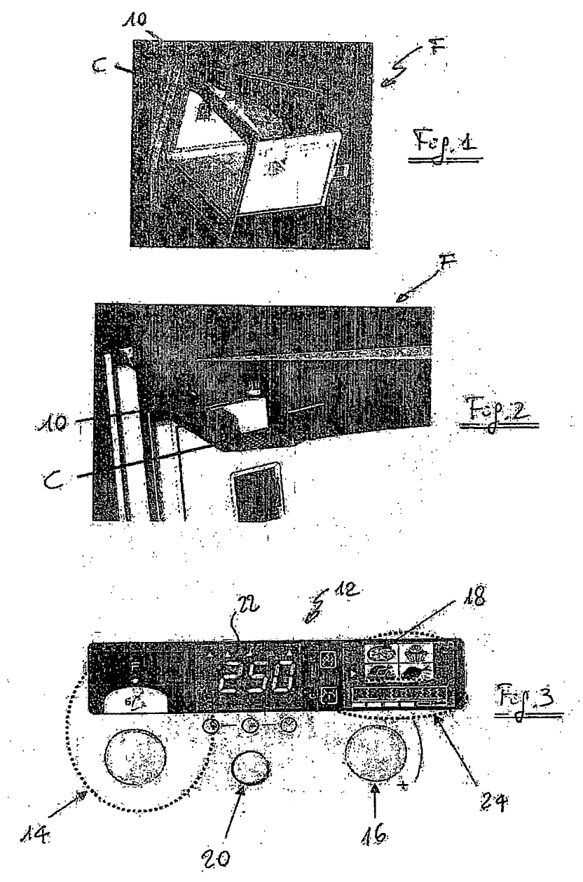

FIG. 1 is a perspective view of an oven according to the invention;

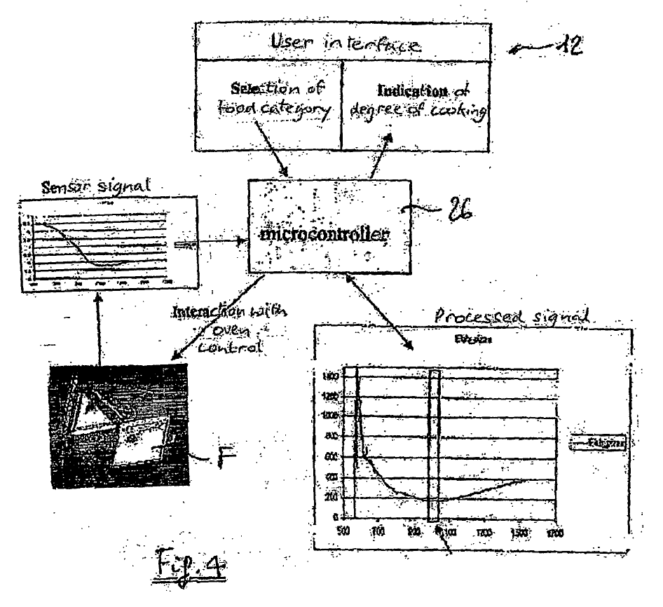

FIG. 2 is a detail on a larger scale of FIG. 1;

FIG. 3 is a front view of the user interface of the oven in FIG. 1;

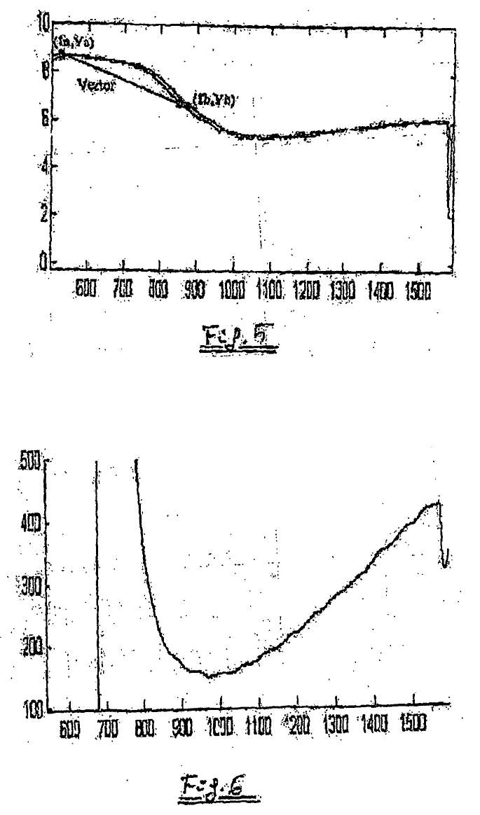

FIG. 4 is a block diagram of the logic for connecting the oven, gas sensor, user interface, microcontroller;

FIG. 5 is a diagram illustrating the variation in the signal of the gas sensor in a particular cooking process in the oven in FIG. 1;

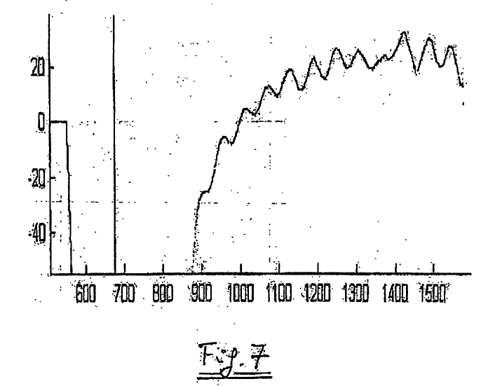

FIG. 6 is a diagram illustrating the course of the signal after suitable processing by the central processing unit of the oven; and

FIG. 7 is a diagram illustrating the course of the gradient of the function shown in FIG. 6.

With reference to the drawings, the reference number 10 is used to indicate the sensor positioned inside a duct C of an oven F; the cooking vapours that leave via the duct C therefore pass through the sensor.

This solution makes it possible for the sensor not to be directly exposed to the cooking gases and therefore not to be soiled by any fat splashes; at the same time it will be subject to lower temperatures than if it were positioned inside the oven. This positioning ensures that the distance from the food is a fair compromise between the solution in which the sensor is placed immediately next to the food (inside the compartment) and that in which it is placed in a suitable chamber outside the compartment and connected by means of suitable tubing. The gas sensor used in the tests carried out by the applicant is sensor model ST-MW2 produced by FIS.

According to the invention, the oven F is provided with a user interface 12 (FIG. 3), with which to set either the automatic cooking function, by means of a knob 14, or the category of food that is to be cooked (pizza, lasagna, chicken, etc.). The food type can be set by means of a selection knob 16. In this case, in the configuration where the food type is set, zones 18 will be shown corresponding to the food category and the user will have to confirm the choice by means of an appropriate push-button 20. Alternatively, the food type can be set by acting directly on the zones 18, shaped like push-buttons, for example of the “touch-control” type (i.e. with no moving parts). The user interface 12 also has a conventional zone 22 for displaying the operating conditions of the oven (temperature, function set etc.) and an innovative zone 24 by means of which the user can set and display the degree of cooking of the food (lightly cooked, normal, well cooked). Said user interface 12 can therefore provide an indication of the cooking level, since each cooking level is associated with a different display. Obviously, the way that the cooking level is illustrated can differ from that illustrated in FIG. 3 and can, for example, use LED bars (light-emitting diodes) of different colours. When the associated LED is illuminated this indicates, for example, that the food is raw, lightly cooked, cooked, well cooked or burnt.

FIG. 4 illustrates diagrammatically the control circuit of the oven controlled by a microprocessor 26 connected to the gas sensor and to the user interface 12. The heating elements of the oven, like other components (fans, thermostats etc.) are not illustrated, but in any case they are also managed by the microprocessor 26.

FIG. 5 illustrates the electrical signal of the sensor and FIG. 6 the processing of said signal in the case, for example, of cooking a pizza.

The processing of the signal provides first of all for the signal to be filtered. Once the signal is obtained from the sensor 10, by sampling at homogeneous intervals equal, for example, to 1 second, pre-filtering has to be applied to it Good results have been achieved by applying a moving-window filter with an amplitude equal to 30 samples. The amplitude of filtering depends on the food type being considered. This filtering algorithm can be replaced by other methods.

As concerns the chosen moving-window filter, its output at the “ith” moment depends on the samples acquired within the time interval preceding said ith moment and with dimensions equal to the amplitude of the filter, in the case cited, therefore, equal to 30 samples:

$${Y}_{i} ( {T}_{i} ) = {\sum }_{j = 1}^{i - n} \frac{\hat{Y} j}{n}$$

Ŷj

where

is the actual signal at the moment Tj.

FIG. 5 shows the course of the signal from the filtered sensor where a pizza is being cooked. Said diagram illustrates a vector with the origin (ta, Ya) and the vertex (tb, Yb) lying over the prefiltered signal. The origin of the vector is chosen in correspondence with the moment when the food is placed in the oven. The vertex describes, moment by moment, the evolution of the prefiltered signal. While the origin of the vector is therefore a point chosen and fixed at the beginning of the algorithm, the vertex moves according the evolution of the signal through time.

By processing the signal Y we get the following signal F(t):

$$F ( t ) = \frac{{( {t}_{a} - {t}_{b} )}^{α}}{{( {Y}_{a} - {Y}_{b} )}^{β}}$$

illustrated in FIG. 6 where a and β are equal to 1.

α and β can assume values other than 1 and can be obtained by experimentation in relation to the food type placed in the oven compartment

The processed signal produced in this way reaches its minimum in a period of time when the food (pizza in the example described) is being cooked, and the gradient of this signal indicates the degree of cooking. A formula for evaluating the gradient can for example be:

$$P ( t ) = \frac{F ( t ) - F ( t - 40 sec )}{K}$$

where K is a constant other than zero.

If P(t) supplies negative values, the function F(t) has a negative gradient as a result and this coincides with the phases prior to the optimal cooking moment. If P(t) takes values close to zero we are close to optimal cooking, i.e. to the minimum of the function F(t). Assuming that P(t) has highly positive values, there is an indication of a very advanced or burnt state of cooking.

By way of example, taking the constant K to be equal to 1, the following experimental intervals are obtained for cooking the pizza:

| | |
|---|---|
| Raw: | P(t) < −60 & P(t) > 60 |
| Lightly cooked: | −60 < P(t) < −10 |
| Cooked: | −10 < P(t) < 5 |
| Well cooked: | 5 < P(t) < 15 |
| Burnt: | P(t) > 15 & P(t) < 60 |

1. Domestic oven, of the type comprising heating means, a gas sensor (10) connected to a central processing and control unit (26) and a user interface (12) connected to said central processing unit by means of which the user can set the type of food placed in the oven compartment, characterised by the fact that the user interface (12) comprises means (18) for setting the desired degree of cooking of the food and by the fact that the central processing unit (26) is capable of processing the signal of the gas sensor (10) in such a way as to determine the cooking end time of the food, the central processing unit being capable of interrupting the power supply to the heating means on the basis either of this cooking end time modified, if necessary, on the basis of the degree of cooking set by the user, or of the food type set by the user.

2. Oven according to claim 1, characterised by the fact that the central processing unit (26) is capable of determining the cooking interval using a function of the signal coming from the gas sensor (10), the temperature of the compartment and the control algorithm for the oven.

3. Oven according to claim 1, characterised by the fact that the central processing unit (26) is capable of determining the cooking interval by analysing the signal from the gas sensor, said analysis providing, in addition to conventional filtering, a study of the gradient and variations in the gradient of said signal, as well as a study of maxima and minima, and a comparison of these characteristics with predetermined values stored in the central processing unit.

4. Oven according to claim 1, characterised by the fact that the central processing unit (26) is capable of filtering the signal from the gas sensor (10), the amplitude of filtering depending on the food type set by the user.

5. Oven according to claim 1, characterised by the fact that the gas sensor (10) is positioned inside the duct (C) of the oven (F).

6. Process for automatic cooking in a domestic oven, of the type comprising the detecting of the signal from a gas sensor (10) and the setting by the user of the food type placed in the oven compartment, characterised by the fact that the cooking interval is determined using a function of the signal coming from the gas sensor (10), the temperature of the compartment and the control algorithm of the oven.

7. Process according to claim 6, characterised by the fact that the cooking interval is determined by analysing the signal from the gas sensor (10), said analysis providing, in addition to conventional filtering, a study of the gradient and variations in the gradient of said signal, as well as a study of maxima and minima, and a comparison of these characteristics with predetermined values stored in the central processing unit.

8. Process according to claim 7, characterised by the fact that it comprises a phase of processing the signal according to a function of the type:
$$F ( t ) = \frac{{( {t}_{a} - {t}_{b} )}^{α}}{{( {Y}_{a} - {Y}_{b} )}^{β}}$$
where:
Yₐ and Y_{b} are the values from the gas sensor at the time ta and tb
α and β are coefficients obtained experimentally for a particular food type,
and searching for the moment when said function F(t) has a minimum, said moment corresponding to the optimal cooking time of the food.

9. Process according to claim 7, characterised by the fact that it also provides for a phase in which the user it sets the desired degree of cooking of the food, said value modifying, if necessary, the moment corresponding to the actual end of cooking.
